(19) United States
(12) Patent Application Publication
(10) Pub. No.: US 2008/0043858 A1
(43) Pub. Date: Feb. 21, 2008

(54) Method for Constructing Frame Preamble in Ofdm Wireless Communication System, and Method for Acquiring Frame Synchronization and Searching Cells Using Preamble

(75) Inventors: Hyoung-Soo Lim, Daejeon-city (KR); Choong-Il Yeh, Daejeon-city (KR); Yu-Ro Lee, Daejeon-city (KR); Dong-Seung Kwon, Daejeon-city (KR); Seung-Ku Hwang, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: ELECTRONICS AND TELECOMMUNICATIONS RESEARCH INSTITUTE, Daejeon (KR); SAMSUNG ELECTRONICS CO., LTD., Suwon-Si, Gyeonggi-Do (KR); KT CORPORATION, Kyeonggi-Do (KR); SK TELECOM CO., LTD., Seoul (KR); KTFREETEL CO., LTD., Seoul (KR); HANARO TELECOM., INC., Seoul (KR)

(21) Appl. No.: 10/584,716

(22) PCT Filed: Oct. 27, 2004
(86) PCT No.: PCT/KR04/02730

§ 371 Date: May 25, 2007

(30) Foreign Application Priority Data
Dec. 26, 2003 (KR) 10-2003-0097867

(51) Int. Cl. H04K 1/10

(52) U.S. Cl. 375/260

(57) ABSTRACT

Disclosed are a method for constructing a frame preamble in an OFDM wireless communication system, and a method for acquiring frame synchronization and searching cells using the preamble. The preamble is arranged at the beginning of a frame and constructed of a pattern repeated an integer number of times, and a CP. The pattern has a length shorter than a single OFDM symbol interval. The length of the repetitive pattern is not limited to an integer number of times a single OFDM symbol interval. Frame synchronization can be acquired by observing cross-correlation of a received signal and reference patterns and detecting the moment when the absolute value of the cross-correlation exceeds a predetermined threshold. Otherwise, frame synchronization can be acquired by observing auto-correlation of the received signal using repeated patterns included in the received signal and detecting the moment when the absolute value of the auto-correlation becomes the maximum value.

### TECHNICAL FIELD

The present invention relates to a frame preamble structure in an OFDM (Orthogonal Frequency Division Multiplexing) wireless communication system. More specifically, the present invention relates to a method for constructing a preamble that can have a length different from an integer number of times an OFDM symbol interval in an OFDM wireless communication system, and a method for acquiring frame synchronization and searching cells using the preamble.

### BACKGROUND ART

Korean Patent No. 2001-50104 (filed on Aug. 8, 2001) discloses “Method of generating symmetric-identical preamble and method of synchronizing symbol/frequency of OFDM signal using the symmetric-identical preamble.” This technique enables symbol timing synchronization using auto-correlation by employing the symmetric-identical preamble. Furthermore, the technique can average phase differences of symmetrically arranged sample pairs for the preamble to estimate a carrier frequency offset. However, when the preamble has a symmetrical structure, it is difficult for the preamble signal to satisfy a given spectrum mask due to non-continuity at the boundary point of repeated patterns. This limits the number of possible patterns.

Korean Patent No. 2001-29456 (filed on May 28, 2001) discloses “Apparatus for automatically controlling gain of OFDM signal and automatic gain controlling method using the same,” which relates to detection of a signal using a preamble having a repeated form and automatic gain control. The disclosed technique detects presence of an effective signal using repeated preambles transmitted before packets, and measures power of the signal to control a gain of the signal in an OFDM system for transmitting packets at a high speed. The technique minimizes a period of time required for controlling the signal gain and maintains stable gain in a digital manner.

In the meantime, in the IEEE 802.16a standard, an international standard using TDD and OFDM methods, an OFDM TDD mode standard has a TTG (Transmit-to-receive Transition Gap) between the end of a downlink frame and the head of an uplink frame, and an RTG (Receive-to-transmit Transition Gap) between the end of an uplink frame and the head of a downlink frame. When the length of an OFDM symbol interval is Ts, the length of a downlink frame in IEEE 802.16a is limited to 3nTs (n is a positive number), and the length of an uplink frame is limited to 3mTs+1 (n is a positive number). This restricts frame structure design.

When a frame length is designed in consideration of ease of frame construction and delay time in data communication, the interval other than the uplink and downlink frames having lengths decided under the aforementioned restrictions can remarkably exceed an appropriate length for the original purposes of the TTG and RTG. The excess wastes system resources to result in remarkable deterioration in system efficiency.

In the meantime, a single OFDM symbol interval is a temporal unit of resource allocation in IEEE 802.16e. Thus, restrictions on the design of frame length are not severe compared to IEEE 802.16a. However, since a single OFDM symbol interval in IEEE 802.16e is as long as the OFDM symbol length in IEEE802.16a, design restrictions and waste of resources still remain.

In addition, even if frames are designed under the restrictions, re-design is not easy when a system parameter is required to be changed, for example, when a repeater is used.

### DISCLOSURE OF INVENTION

### Technical Problem

It is an object of the present invention to provide an efficient preamble structure in an OFDM communication system. That is, the present invention provides a method of using an interval of a single frame other than an uplink frame, a downlink frame, and intervals for a TTG and RTG as a preamble in the case of an OFDM TDD mode of IEEE802.16a or IEEE802.16e.

It is another object of the present invention to provide a method for constructing a preamble in which the preamble is constructed such that the same pattern is repeated in the time domain by the number of times decided based on a frame structure, to thereby design the frame structure unrestrictedly and minimize waste of time and frequency resources.

It is a still another object of the present invention to provide a method for acquiring frame synchronization and searching cells based on cross-correlation and auto-correlation, which effectively utilizes time and frequency resources while mitigating restrictions on frame structure design, reduces complexity, and avoids normalization using hard-limiting.

### Technical Solution

In one aspect of the present invention, a method for constructing a frame preamble in an OFDM wireless communication system comprises a) arranging a preamble at the beginning of a frame; and b) repeatedly arranging a pattern, which has a length shorter than a single OFDM symbol interval, an integer number of times. The length of the repetitive pattern is not limited to an integer number of times the single OFDM symbol interval.

In another aspect of the present invention, a method for constructing a frame preamble in an OFDM wireless communication system comprises a) arranging a preamble at the beginning of a frame; and b) repeatedly arranging a pattern shorter than a single OFDM symbol interval in such a manner that the pattern is phase-shifted in the time dimension and repeatedly arranged an integer number of times such that adjacent cells have different subcarrier offsets of pilot subcarriers arranged at a specific interval in the frequency dimension. The length of the repetitive pattern is not limited to an integer number of times the single OFDM symbol interval.

In another aspect of the present invention, a method for acquiring frame synchronization and searching cells based on cross-correlation using a preamble having a length that does not correspond to an integer number of times an OFDM symbol interval comprises a) observing cross-correlation of a received signal and reference patterns and detecting the moment when the absolute value of cross-correlation exceeds a predetermined threshold to acquire frame synchronization; and b) observing cross-correlation of the received signal and reference patterns after the frame synchronization is acquired and detecting the moment when the absolute value of cross-correlation exceeds the predetermined threshold to carry out cell search.

The a) and b) comprise i) measuring the power level of the received signal; ii) normalizing a result of calculation of the cross-correlation using the measured power level; and iii) applying the normalized result to the threshold.

The method further comprises calculating an average phase difference among the repeated patterns constructing the preamble appearing during a predetermined interval to estimate a carrier frequency based on the frame synchronization acquired at the a) after the b).

In another aspect of the present invention, a method for acquiring frame synchronization and searching cells based on cross-correlation using a preamble having a length that does not correspond to an integer number of times an OFDM symbol interval comprises a) observing auto-correlation having a time interval of a basic pattern constructing a preamble for a received signal; b) normalizing the observed auto-correlation using the power level of the received signal; c) detecting the moment when the absolute value of the normalized result exceeds a predetermined threshold to acquire frame synchronization; and d) after the frame synchronization is acquired, observing auto-correlation having the time interval of the basic pattern constructing the preamble for the received signal to carry out cell search.

The method further comprises calculating an average phase difference among the repeated patterns constructing the preamble appearing during a predetermined interval to estimate a carrier frequency based on the acquired frame synchronization between the c) and d).

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1(a) illustrates a case in which the total length of a frame preamble exceeds a single OFDM symbol interval in an OFDM wireless communication system;

FIG. 1(b) illustrates a case in which the total length of the preamble is shorter than the single OFDM symbol interval;

FIG. 2 is a block diagram of a cross-correlation-based frame synchronization acquisition algorithm according to an embodiment of the present invention;

FIG. 3 is a block diagram of a cross-correlation-based frame synchronization acquisition algorithm in which hard-limiting is applied to a received signal and reference patterns according to an embodiment of the present invention;

FIG. 4 shows absolute values of cross-correlation between a preamble and a corresponding reference pattern according to an embodiment of the present invention;

FIG. 5 shows a magnified portion corresponding to the first repetitive pattern timing of FIG. 4;

FIG. 6 shows absolute values of cross-correlation when hard-limiting is applied to both of a received signal and reference patterns according to an embodiment of the present invention;

FIG. 7 shows the result of a simulation of time-dimension frame synchronization acquisition and cell searching performances in a multi-cell environment according to an embodiment of the present invention;

FIG. 8 shows the result of a simulation of time-dimension frame synchronization acquisition and cell searching performances when hard-limiting is applied to a received signal and reference patterns in a multi-cell environment according to an embodiment of the present invention;

FIG. 9 is a flow chart showing a time-dimension initial synchronization acquisition and cell searching algorithm according to an embodiment of the present invention;

FIG. 10 shows absolute values of cross-correlation between a reference pattern corresponding to a received preamble and the received preamble signal according to an embodiment of the present invention;

FIG. 11 shows absolute values of cross-correlation between a reference pattern that does not correspond to a received preamble and the received preamble signal according to an embodiment of the present invention;

FIG. 12 shows the performance of a cross-correlation-based frame synchronization acquisition and cell searching algorithm for a multi-channel environment having a fixed path gain according to an embodiment of the present invention;

FIG. 13 shows the result of a simulation of performance of an auto-correlation-based initial synchronization acquisition algorithm according to an embodiment of the present invention;

FIG. 14 shows the result of a simulation of performance of an auto-correlation-based initial synchronization acquisition algorithm for a timing error that does not correspond to an integer number of times a sample interval according to an embodiment of the present invention;

FIG. 15 illustrates a sliding summer having low complexity according to an embodiment of the present invention;

FIG. 16 shows the result of a simulation of performance of a frequency-dimension initial synchronization acquisition and cell searching algorithm that applies hard-limiting to a received signal according to an embodiment of the present invention;

FIG. 17 shows the result of a simulation of performance of an auto-correlation-based frame synchronization acquisition and cell searching algorithm for a multi-channel environment having a fixed path gain according to an embodiment of the present invention;

FIG. 18(a) illustrates a case in which the total length of a time-dimension preamble exceeds a single OFDM symbol interval when adjacent cells have different subcarrier positions; and

FIG. 18(b) illustrates a case that the total length of the preamble is shorter than the single OFDM symbol interval.

### BEST MODE FOR CARRYING OUT THE INVENTION

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

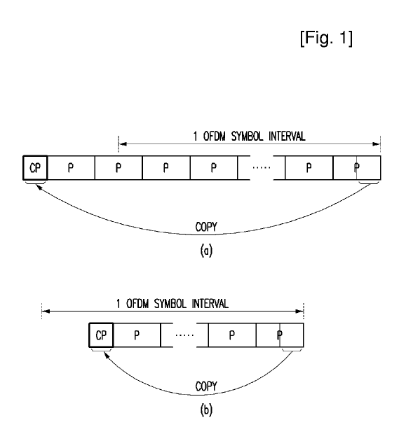

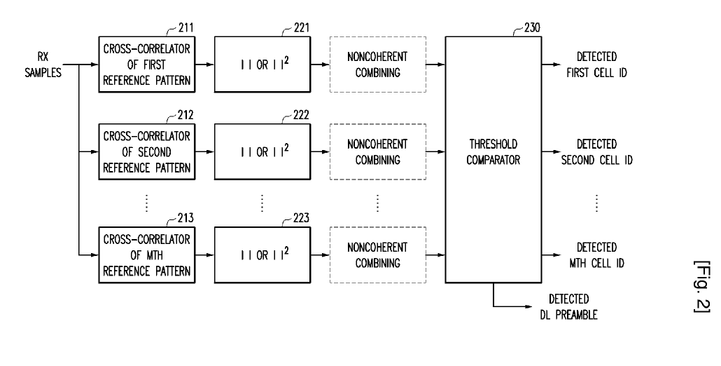

FIG. 1 illustrates a frame preamble in the time dimension in an OFDM wireless communication system according to an embodiment of the present invention. FIG. 1(a) illustrates a case in which the total length of the frame preamble exceeds a single OFDM symbol interval, and FIG. 1(b) illustrates a case in which the total length of the preamble is shorter than the single OFDM symbol interval.

In FIGS. 1(a) and 1(b), p denotes a repetitive pattern constructing the preamble. When the length of an effective OFDM symbol interval other than a CP (cyclic prefix) in a single OFDM symbol interval is T_{b}, the length of the repetitive pattern corresponds to T_{b}/N. The structure constructed such that the same pattern is repeated, as shown in FIG. 1, can be easily obtained by OFDM-modulating a frequency-dimension preamble pilot symbol represented as follows.

$${C}_{k} = \{ \begin{matrix}{P}_{k / N} & k = \pm N , \pm N , … , \pm {N}_{FFT} \\ 0 & k = 0 \\ 0 & otherwise\end{matrix}$$

Here, Pₙ denotes a frequency-dimension preamble pattern and N_{FFT} represents the number of the entire subcarriers including a null subcarrier.

In the construction of an IFFT input vector of a transmitter, a signal formed in a manner such that a specific pattern having a length corresponding to 1/N of an effective OFDM symbol is repeated can be generated by modulating a subcarrier symbol that is not zero at an interval of N subcarriers.

In the embodiment of the present invention, the length of the preamble corresponds to the sum of the length of the CP and an integer number of times the length of the repetitive pattern. The length of the preamble in the time dimension can be shorter or longer than a single OFDM symbol interval, which is easily realized through cyclic repetition or truncation of an IFFT output vector of an OFDM modulator of the transmitter. Here, the CP length is not required to be identical to the length of CP of a data OFDM symbol transmitted after the preamble. Thus, there is no restriction on the preamble length as long as synchronization acquisition and cell searching performances satisfy requirements. While the preamble is constructed of the repetitive patterns and CP in the embodiment, the preamble can be constructed of only the repetitive patterns. That is, the CP length can be zero.

In the case where all cells in a cellular structure use the same frequency band, subcarrier symbol streams are differently modulated for different respective cells such that a cell to which a signal received by a terminal belongs can be detected.

The preamble is used for frame synchronization acquisition, carrier frequency acquisition, channel estimation, cell search, and so on. The carrier frequency acquisition and channel estimation can be carried out using widely known methods, so the present invention describes only the frame synchronization acquisition and cell search.

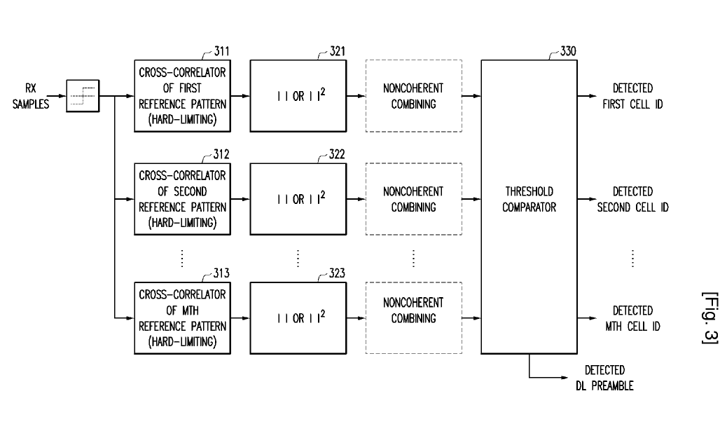

FIG. 2 is a block diagram of a cross-correlation-based frame synchronization acquisition algorithm according to an embodiment of the present invention. This algorithm corresponds to a method of carrying out frame synchronization acquisition and cell search in the time dimension.

If there are M preamble patterns, absolute values of cross-correlation of a received signal and M reference patterns are observed. The moment when the absolute value of any one of outputs of M cross-correlators 211, 212, and 213 or the square 221, 222, or 223 of the absolute value exceeds a predetermined threshold corresponds to the moment when the first one of patterns repeated N times in a preamble has been received. The algorithm using cross-correlation observes output values of the M cross-correlators and identifies cells from reference patterns corresponding to cross-correlators for which a noncoherent combining result value exceeds the threshold to reduce the effect of background noise. The noncoherent combining result value corresponds to the sum of the absolute values of the outputs of the cross-correlators or the sum of the squares of the absolute values. Here, the optimum threshold largely depends on the power level of the received signal or channel situation. This problem can be solved by normalizing cross-correlation with the power of the received signal.

The method using cross-correlation requires cross-correlators for respective preamble patterns of adjacent cells. When the number of preamble patterns is increased in order to arrange cells unrestrictedly, complexity in construction of the algorithm is increased. In many cases, a cross-correlation characteristic is partly maintained even if reference patterns and a received signal are quantized or hard-limited. When a frame synchronization acquisition algorithm as shown in FIG. 3 is realized using the quantization and hard-limiting, the performance is deteriorated but configuration complexity can be remarkably reduced. Particularly, the configuration complexity is further decreased because the normalization process is unnecessary when a received signal is hard-limited.

FIG. 3 is a block diagram of a cross-correlation-based frame synchronization acquisition algorithm in which hard-limiting is applied to a received signal and reference patterns according to an embodiment of the present invention. In FIG. 3, reference numeral 340 denotes a quantization means or a hard-limiting means.

In the meantime, the length of the repetitive pattern is considerably long when a received signal has a carrier frequency offset. Thus, an excess of 90 degrees of phase shift in a single pattern interval due to the carrier frequency offset causes performance deterioration of more than 3 dB. Accordingly, the length of a single pattern must be shorter than the maximum pattern length calculated based on the maximum carrier offset.

An initial synchronization process including a frame synchronization acquisition step when the cross-correlation-based frame synchronization acquisition algorithm is used will now be explained.

(1) Frame timing acquisition: All of available time domain preamble patterns and a received signal are continuously cross-correlated to detect a moment when at least one of output values of correlators has a large value to detect preamble timing.

(2) Cell search: Preamble patterns corresponding to predetermined correlators having output values whose absolute values exceed a threshold are received at the same time the frame timing is acquired. When a preamble pattern corresponding to a correlator whose output value has a maximum absolute value is detected, it can be judged that an optimum cell has been found. That is, frame timing acquisition and cell search can be simultaneously carried out.

(3) Carrier frequency acquisition: An average phase difference among repetitive patterns appearing during a predetermined interval is calculated based on the acquired preamble timing to estimate a carrier frequency.

In the meantime, a frame timing error between adjacent cell signals is smaller in a hand-off process than the frame timing error in the initial synchronization acquisition step. Thus, a timing window for acquiring frame timing and a candidate PN code set for cell identification are restrictedly given for hand-off. Furthermore, a separate carrier frequency acquisition step can be omitted in the hand-off process because a carrier frequency error between adjacent cell signals is sufficiently small.

FIG. 4 shows absolute values of cross-correlation between a preamble and a corresponding reference pattern according to an embodiment of the present invention. Here, assume that the preamble has a structure in which the same pattern is repeated six times, the length of each pattern is ⅛ of an effective OFDM symbol interval, and an FFT size, that is, the number of subcarriers including a null subcarrier, is 2048. In addition, assume that an OFDM signal having modulated random data is received after the preamble, a channel has no noise or distortion, an OFDM sample frequency is 11.42 MHz, and an initial carrier frequency offset is 11.63 kHz.

Referring to FIG. 4, a correlation value such as noise appears in intervals other than preamble-receiving intervals, and very large correlation values appear at the moments corresponding to repeated timing of the preamble pattern in short preamble intervals. A very small correlation value appears in other intervals.

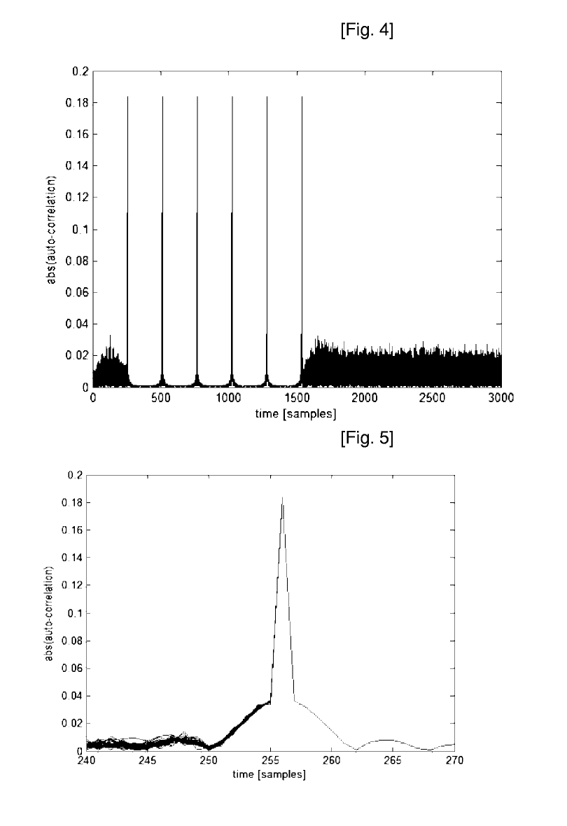

FIG. 5 magnifies a portion corresponding to the first repetitive pattern timing of FIG. 4. It can be known from FIG. 5 that timing resolution of the frame synchronization acquisition algorithm using cross-correlation corresponds to a single sample interval, which is also observed when the other five repeated patterns are received.

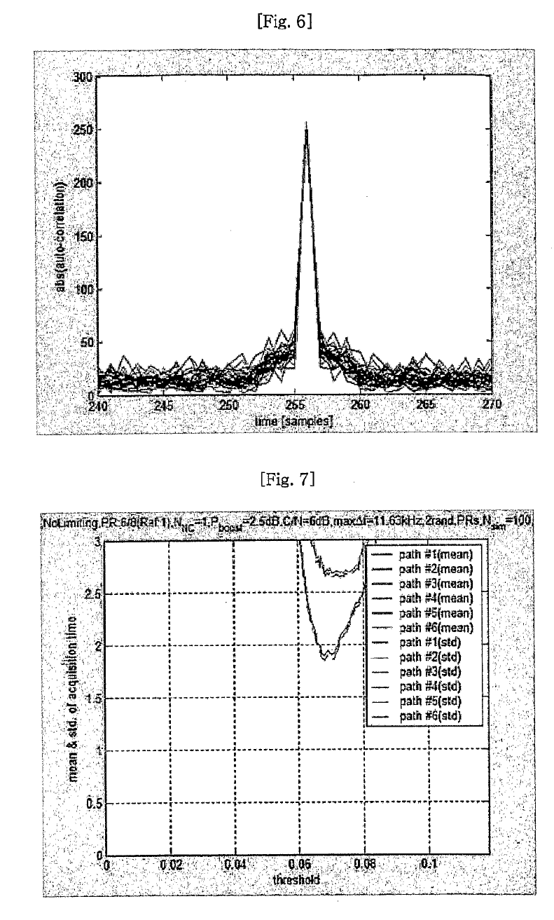

FIG. 6 shows absolute values of cross-correlation when hard-limiting is applied to both of a received signal and reference patterns according to an embodiment of the present invention. Referring to FIG. 6, it can be known that dispersion of absolute values of cross-correlation during intervals other than repeated pattern timing of the preamble is slightly increased and timing resolution still corresponds to a single sample interval.

FIG. 7 shows the result of a simulation of time-dimension frame synchronization acquisition and cell searching performances in a multi-cell environment according to an embodiment of the present invention. Here, assume that preamble signals are simultaneously received from adjacent three cells and a signal from a target cell is received via a fading channel conforming to the pedestrian-B channel model described in election Procedures for the choice of radio transmission technologies of the UMTS appearing in the May, 1997 issue of UMTS 30.03 v3.0.0, ETSI. In addition, assume that signals from the two cells other than the target cell are received via a LOS (Line Of Sight) channel.

In FIG. 7, a solid line represents average synchronization acquisition time with respect to the multi-path signals and a dotted line represents the standard deviation of synchronization acquisition time with respect to the multi-path signals. From the result shown in FIG. 9, it can be known that about two frames are required for acquiring frame synchronization in case of a signal of a channel having the largest channel gain.

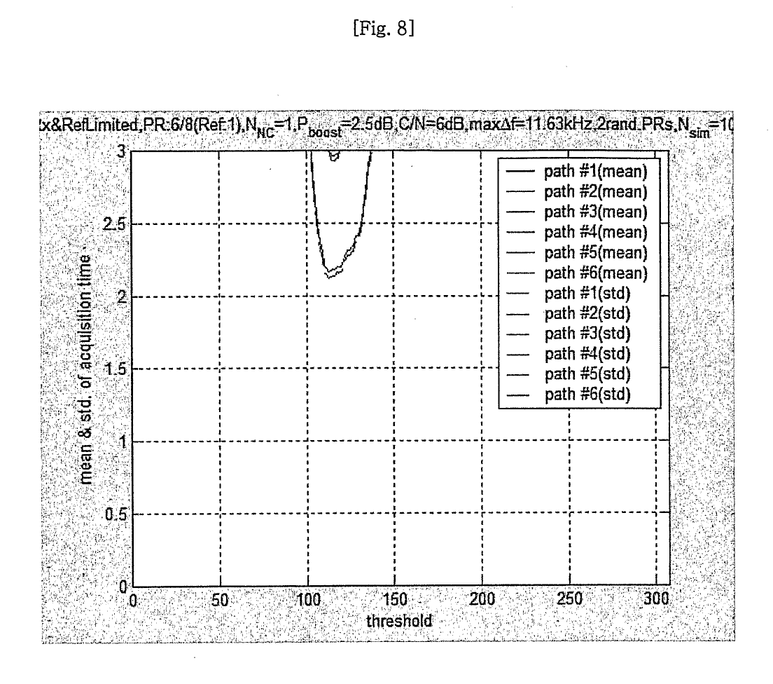

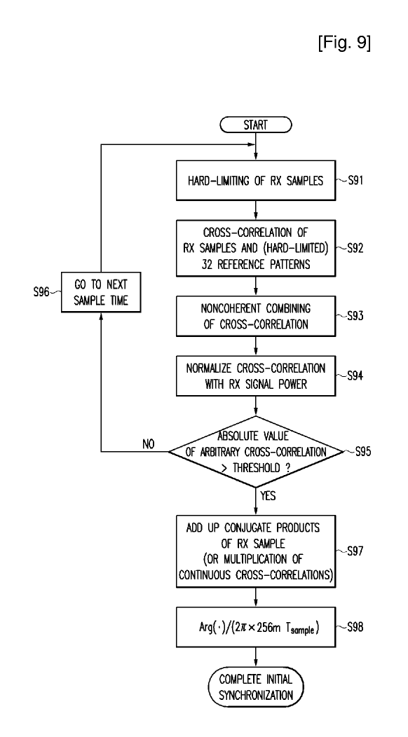

FIG. 8 shows the result of a simulation of time-dimension frame synchronization acquisition and cell searching performances when hard-limiting is applied to a received signal and reference patterns in a multi-cell environment according to an embodiment of the present invention.

FIG. 8 shows the result of a simulation of the average and standard deviation of frame synchronization acquisition time when both of the received signal and reference patterns are hard-limited in consideration of configuration complexity of the cross-correlation-based frame synchronization acquisition algorithm. From the result shown in FIG. 8, it can be known that the configuration complexity of the algorithm is remarkably improved, but the performance is not seriously deteriorated.

FIG. 9 is a flow chart showing a time-dimension initial synchronization acquisition and cell searching algorithm according to an embodiment of the present invention. FIG. 9 shows an example of a process of acquiring initial synchronization including the cross-correlation-based frame synchronization acquisition step when the preamble according to the present invention is used.

Referring to FIG. 9, RX samples corresponding to a received signal are hard-limited in the step S91, and the RX samples and hard-limited reference pattern are cross-correlated in the step S92. Then, the cross-correlations are noncoherent-combined in the step S93.

The cross-correlations are normalized with the power of the RX signal in the step S94, and it is judged whether the absolute value of arbitrary cross-correlation is larger than a threshold in the step S94. When the absolute value is not larger than the threshold, the process goes to a next sample interval in the step S96. When the absolute value is larger than the threshold, conjugate products of the RX samples are summed up or a product of continuous cross-correlations is obtained in the step S97 and then a carrier frequency offset is estimated in the step S98.

The time-dimension frame synchronization acquisition and cell searching algorithm has the following problems.

Firstly, the received signal and many reference patterns should be cross-correlated when hard-limiting is not applied to the received signal and reference patterns. This increases complexity in construction of the algorithm.

Secondly, since cell search must be carried out within several frames in the event of hand-off, cross-correlation should be executed for all of candidate reference patterns for every sample within a timing window of a predetermined range based on the current frame timing. This requires high power consumption.

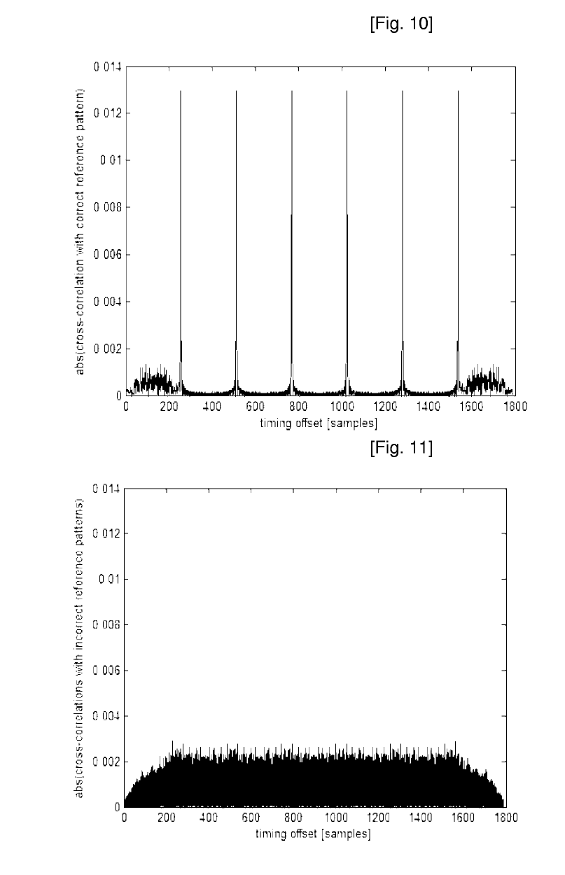

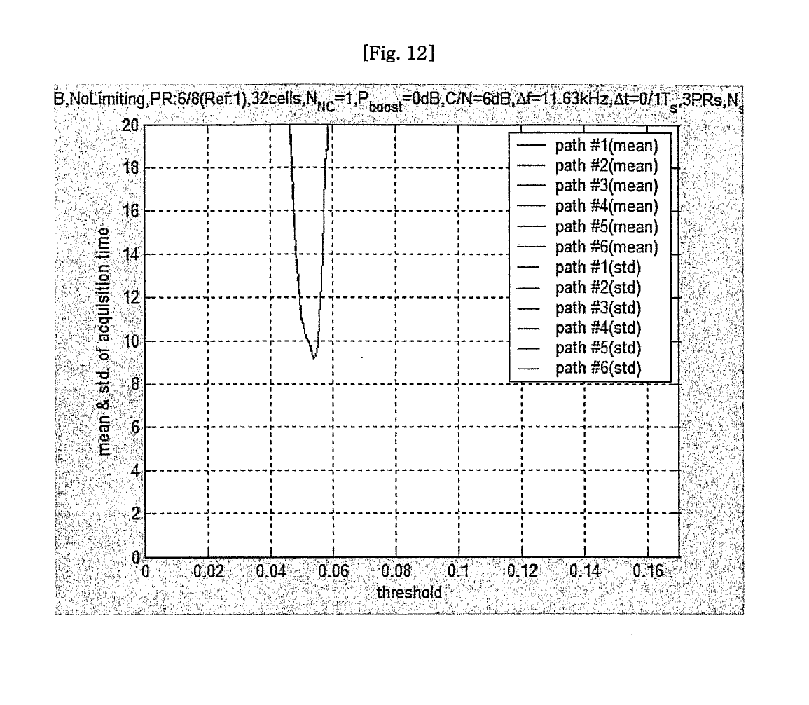

FIG. 10 shows absolute values of cross-correlation between a reference pattern corresponding to a received preamble and the received preamble signal according to an embodiment of the present invention, and FIG. 11 shows absolute values of cross-correlation between an incorrect reference pattern that does not correspond to a received preamble and the received preamble signal according to an embodiment of the present invention. As shown in FIGS. 10 and 11, maximum values of cross-correlation of the received preamble and reference patterns other than a correct reference pattern correspond to 20% of a cross-correlation value of the preamble and the correct reference pattern. Accordingly, if preamble signals having the same power and arbitrary phases are received from three adjacent cells with arbitrary timing, the sum of two preamble signals other than the preamble signal received from a target cell corresponds to at most 40% of a cross-correlation value of the preamble signal from the target cell and a reference pattern of the target cell.

In a channel environment such as the pedestrian-B channel model, for example, a signal of a path having a maximum gain is received with power of approximately 40% of the total signal power. Thus, if a terminal, which receives downlink signals having similar power from three adjacent cells, receives a signal from the target cell through the pedestrian-B channel and receives signals from the other two cells through a LOS channel, frame synchronization acquisition and cell identification performances will be remarkably reduced.

Practically, the average frame synchronization acquisition time with respect to the pedestrian-B channel is less than two frames in FIG. 7. This is observed for a channel gain varying with time. When a simulation is executed for an environment where the channel gain does not vary with time, that is, a channel environment fixed with an average gain of multiple paths given by the pedestrian-B channel model, the result shown in FIG. 12 is obtained.

The aforementioned performance deterioration occurs because the cross-correlation-based frame synchronization acquisition algorithm individually detects multi-path signals. To avoid this, a method of combining cross-correlation results with respect to all (or a part) of the multi-path signals is required. However, it is impossible to combine the cross-correlation results because even the detection of each of the multi-path signals is not guaranteed.

When the cross-correlation results with respect to the multi-path signals are not combined, cell searching performance can be considerably deteriorated due to the multi-path channel situation. For instance, when three adjacent cells A, B, and C exist, a signal from the cell A is received via three multi-path channels, having ⅓ power level for each channel, and signals from the cells B and C each of which has ½ power level are received through a LOS channel, the cell A should be judged to be the optimum cell because a total reception power of the cell A is high. However, if the multi-path signals are not combined as described above, a preamble signal of the cell B or C, which is received with a power level higher than the reception power level of each of the three multi-path signals from the cell A, is judged to be a preamble signal of the optimum cell.

Finally, the cross-correlation-based frame synchronization acquisition algorithm is subjected to performance deterioration when a timing error that does not correspond to an integer number of times a sample interval is generated. The cross-correlation-based frame synchronization acquisition algorithm detects timing of a received preamble signal as resolution of a single sample. Accordingly, when a sampling timing error corresponding to less than a single sample is generated, the maximum absolute value of cross-correlation is reduced and thus frame synchronization acquisition and cell searching performances are deteriorated. To limit the performance deterioration due to the sampling timing error within 1 dB, at least twice over-sampling is required, which increases complexity in construction of the algorithm.

The present invention provides an auto-correlation-based frame synchronization acquisition algorithm as one of methods for solving the above-described various problems.

The auto-correlation-based frame synchronization acquisition algorithm observes auto-correlation having a time interval of T_{b}/N for a received signal using the fact that a preamble is constructed such that a specific pattern having a length of T_{b}/N is repeated K times in the time dimension. To reduce effects of a channel state and a power level of the received signal, frame synchronization is acquired by normalizing auto-correlation with the received signal power and then detecting the moment when the absolute value of the normalized auto-correlation exceeds a predetermined threshold or detecting the moment when the absolute value becomes the maximum value. The frame synchronization acquisition algorithm using auto-correlation is not affected by a carrier frequency offset so that the algorithm is not limited by the length of a repetitive pattern. Furthermore, complexity in construction of the auto-correlation-based frame synchronization acquisition algorithm is considerably lower than that of the cross-correlation-based frame synchronization acquisition algorithm without employing hard-limiting. However, a timing error of a frame synchronization acquisition result of the algorithm using auto-correlation can be larger than that of the algorithm using cross-correlation.

Cell search using preambles having the constructions shown in FIGS. 1(a) and 1(b) can be carried out in the time dimension and frequency dimension. The time-dimension cell search has been described above. The frequency-dimension cell search is carried out as follows.

Subcarrier symbol streams arranged at an interval corresponding to N subcarriers are modulated differently for respective cells in a preamble generating process to generate preambles that are different for the respective cells. A terminal OFMD-demodulates the preambles and cross-correlates all reference symbol streams and preambles in the frequency dimension to detect a case where the absolute value of cross-correlation becomes the maximum value, to thereby search for an optimum cell.

When the length of each preamble is shorter than a single OFDM symbol interval, the preamble or only a part of the preamble is input to an FFT input vector of a receiver of the terminal and the rest of the FFT input vector is filled with 0s, and then FFT is executed to restore the subcarrier symbol streams transmitted to the terminal. Here, the preamble pattern after OFDM demodulation can be appropriately restored only when the preamble length corresponds to an integer number of times the length of the repetitive pattern.

When the preamble length is longer than the single OFDM symbol interval, a general OFDM demodulation process is performed during an integer number of times the single OFDM symbol interval and the restoration process used when the preamble length is shorter than a single OFDM symbol interval is carried out during intervals in which the preamble length is shorter than the single OFDM symbol interval. Then, the results of the two processes are combined.

An initial synchronization acquisition process when the frequency-dimension cell search is employed is as follows.

(2) Carrier frequency acquisition: The approximate preamble timing is detected, and then an average phase difference among repeated patterns in the preamble interval is calculated to estimate a carrier frequency.

(3) Cell search: The preamble signal for which an initial carrier frequency error has been estimated and compensated is OFDM-demodulated, and the preamble signal and all available preamble patterns are cross-correlated to search for patterns having large absolute values of cross-correlation, thereby detecting received preamble patterns. Here, the preamble patterns are detected using differential demodulation in the frequency domain because a frame timing acquisition error exists and cell identification is carried out prior to channel estimation. That is, since most adjacent subcarriers demodulated with a symbol that is not 0 in the frequency-dimension preamble patterns have similar channel characteristics, the preamble signals are differentially demodulated in the frequency dimension to compensate for a channel gain, and then cross-correlation of frequency-domain reference patterns and the differentially demodulated patterns is observed.

Similar to the cross-correlation-based initial synchronization acquisition algorithm, a frame timing error and a carrier frequency error between adjacent cell signals are small in the event of hand-off in the auto-correlation-based initial synchronization acquisition algorithm. Thus, only a cell searching process for a limited number of preamble patterns is carried out.

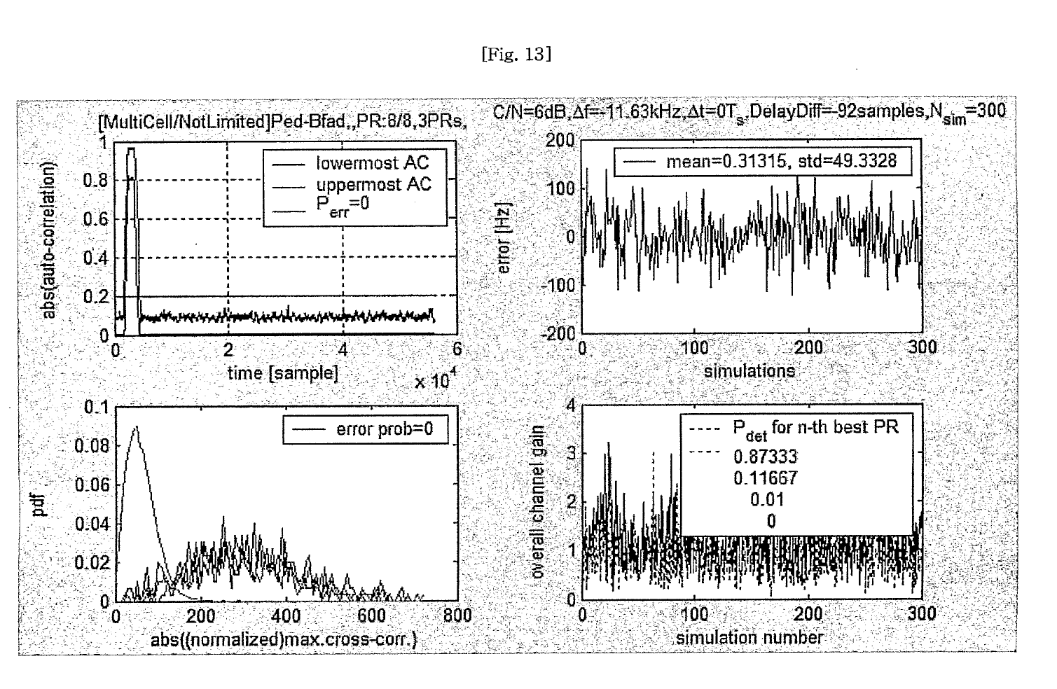

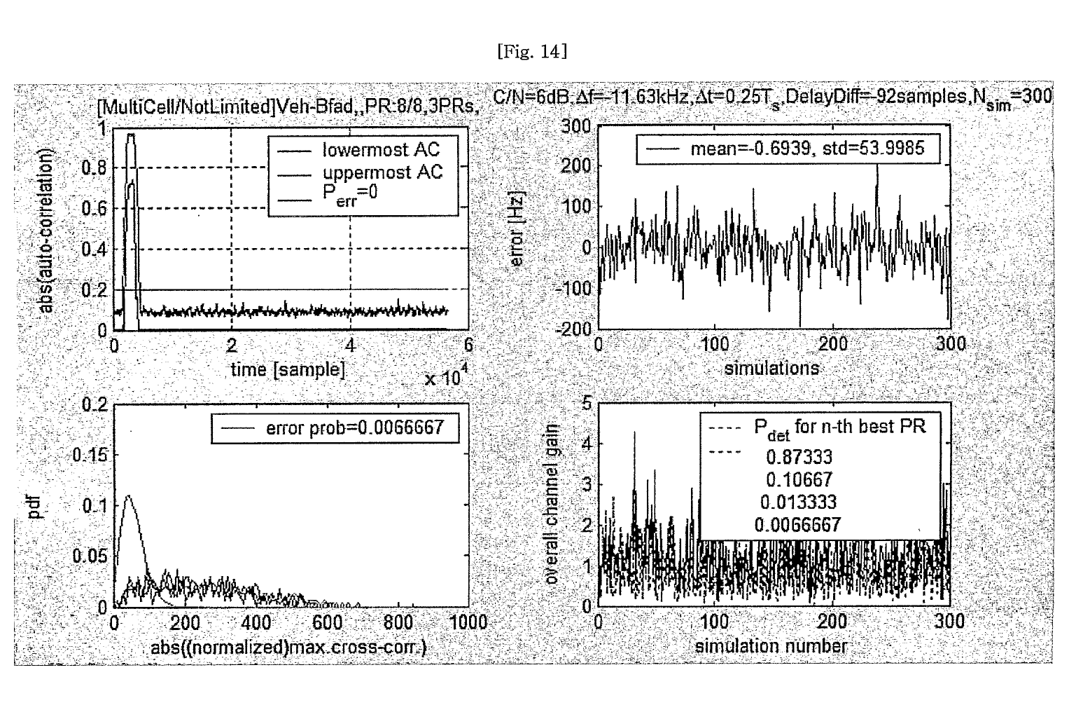

FIG. 13 shows the result of a simulation of performance of an auto-correlation-based initial synchronization acquisition algorithm according to an embodiment of the present invention. In the simulation, a threshold was applied to auto-correlation-based frame synchronization acquisition and auto-correlation was normalized with an average power calculated for a received signal corresponding to an auto-correlation interval and compared with the threshold in consideration of a fading channel varying with time.

The condition of the simulation with respect to FIG. 13 is identical to the condition of the simulation of the performance of the cross-correlation-based frame synchronization acquisition algorithm except that a preamble in the simulation of FIG. 13 is constructed of a pattern repeated eight times. The number of times of repeating the pattern constructing the preamble can be smaller or larger than 8. While the number of times of repeating the pattern corresponds to 8 in the embodiment of the present invention, the length of the repetitive pattern practically used for each step of the initial synchronization is ½ to ¾ of an effective OFDM symbol interval. Accordingly, the result of the simulation shows whether satisfactory performance is obtained or not, and a fundamental operation characteristic rather than providing accurate numerical values.

In FIG. 3, the upper left graph shows uppermost and lowermost values with respect to each sample timing offset, obtained by observing the absolute value of auto-correlation for each frame in the auto-correlation-based frame synchronization acquisition. That is, the absolute values of auto-correlation for respective frames are distributed between the two curves. The numeral represented in the explanatory notes means error probability in the frame synchronization acquisition.

The upper right graph of FIG. 3 shows a carrier frequency error detection result after the frame synchronization is acquired, and the mean and standard deviation of a detected error.

The lower left graph of FIG. 3 shows a distribution of absolute values of frequency-dimension cross-correlation for preamble patterns corresponding to preamble signals received from three adjacent cells, and a distribution of absolute values of cross-correlation for other preamble patterns that do not correspond to the received preamble signals. In the graph, the former corresponds to a gentle distribution and the latter corresponds to an abrupt distribution. The explanatory notes represent probability of cell search error, which is generated when the uppermost value of the absolute values of cross-correlation for the preamble patterns that do not correspond to the received preamble signals becomes larger than the absolute values of cross-correlation for the preamble patterns corresponding to the received preamble signals.

The lower fight graph of FIG. 13 shows the entire channel gain of a preamble interval of each frame for the signal from each cell. In addition, the graph represents a cell signal having the uppermost absolute value of cross-correlation, detected by cell identification. Here, the entire channel gain means an ideal channel gain corresponding to a sum of power gains of all multi-path signals in a multi-path channel environment. The graph also shows an optimum cell judgement result of the frequency-dimension cell search algorithm for each frame in the explanatory notes. The explanatory notes represent probabilities of judging cells to be an optimum cell according to the frequency-dimension cell searching algorithm in the order of a preamble signal having the maximum channel gain through a preamble signal having the minimum channel gain. The lowermost numeral means probability of misjudging that a cell preamble, which does not correspond to the received preamble signals, is received.

Referring to the upper left graph of FIG. 13, it can be known that the auto-correlation characteristic is distinctly observed in the preamble interval from the pulse waveform shown in the left part of the graph. In addition, it can be known that auto-correlation-based frame synchronization is successively acquired.

Referring to the upper right graph of FIG. 13, it can be known that a standard deviation of approximately 1% of a frequency interval between subcarriers can be obtained by estimating and compensating for the carrier frequency offset using a preamble. However, this result is obtained by estimating and compensating for the carrier frequency offset using only a single preamble. Thus, when a closed loop structure that repeats estimation and compensation processes over multiple frames to gradually reduce the offset is used, more accurate carrier frequency reproduction function can be obtained.

From the lower graphs of FIG. 13, it can be known that the cell search performance is satisfactory, probability of successively detecting the optimum cell is approximately 87.3%, and probabilities of detecting the second and third optimum cells are 11.7% and 1% respectively. Here, a sum of the probabilities of detecting the first and second optimum cells reaches approximately 99% when the generation of cases where channel gains to which the first, second, and third optimum cell signals are subjected have a similar value instantaneously is considered. This means performance having very high reliability. In the simulation of FIG. 13, the probability of misjudging a cell to be a cell that does not correspond to a received preamble was very low, and thus it was not observed within a simulation execution range.

FIG. 14 shows the result of a simulation of performance of an auto-correlation-based initial synchronization acquisition algorithm for a timing error that does not correspond to an integer number of times a sample interval according to an embodiment of the present invention. Referring to FIG. 14, the auto-correlation-based frame synchronization acquisition algorithm does not have the problem that the cross-correlation-based frame synchronization acquisition algorithm is subjected to performance deterioration for the timing error that does not correspond to an integer number of times the sample interval. Distinguished from the cross-correlation-base algorithm, the auto-correlation-based algorithm uses repetitiveness of a received signal and thus the performance of the auto-correlation-based algorithm is not affected by the timing error only when the auto-correlation interval is included in the preamble interval.

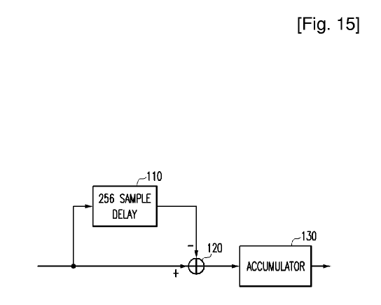

In the meantime, calculation of auto-correlation for a received signal for acquiring frame synchronization must execute a sliding sum for complex conjugate multiplication of a received signal delayed by the length of a repetitive pattern and the current received signal. For this, the auto-correlation-based frame synchronization acquisition algorithm requires a complex multiplier, a sliding summer, and a shift register having the same length as the length of the repetitive pattern. While the number of components constructing the auto-correlation-based algorithm is much smaller than the number of components constructing the cross-correlation-base algorithm, the auto-correlation-based algorithm needs the sliding summer because the algorithm must calculate a new auto-correlation for each sample due to its structure of detecting a preamble start point. The sliding summer can be constructed of a shift register 110, an adder 120, and an accumulator 130 in consideration of configuration complexity, as shown in FIG. 15. FIG. 15 illustrates a sliding summer having low complexity according to an embodiment of the present invention. However, when the accumulator 130 is used, error propagation can be generated.

In the meantime, hard-limiting can be used for a received signal in the auto-correlation-base algorithm as in the cross-correlation-based algorithm, such that complexity in construction of the auto-correlation-based algorithm can be remarkably reduced. In this case, normalization of auto-correlation with reception power is not needed and the sliding summer can be simply constructed of a shift register, a 1-bit full adder, and an up/down counter. Furthermore, error propagation is not generated.

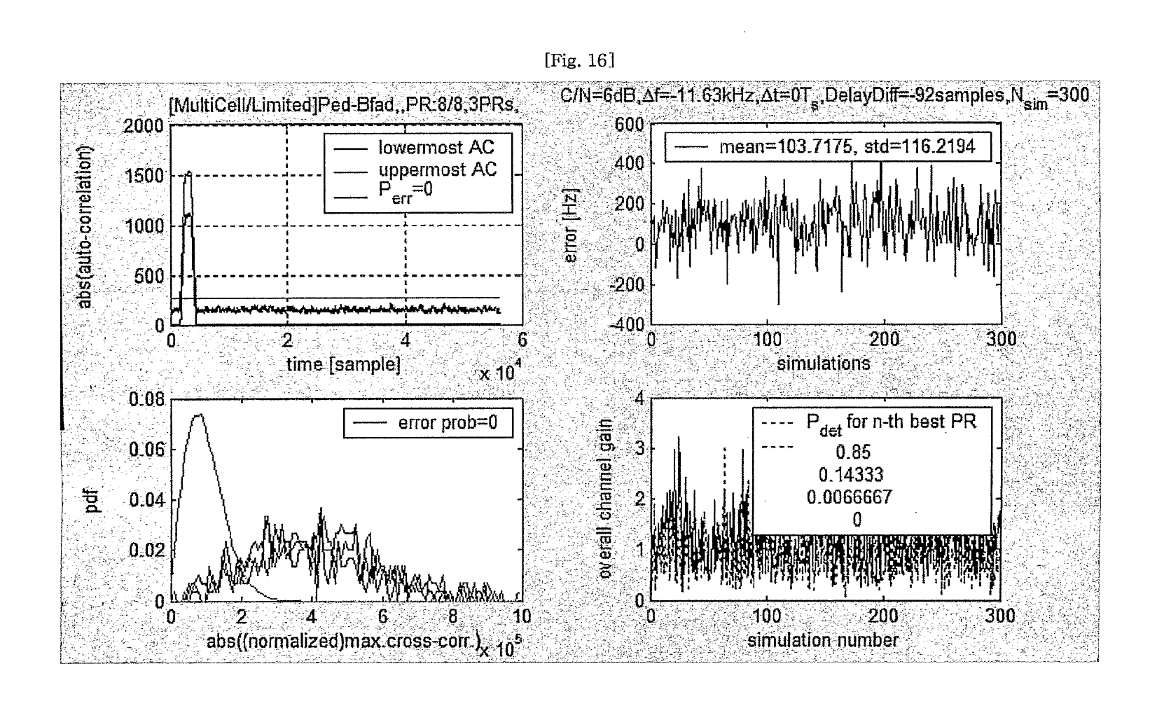

FIG. 16 shows the result of a simulation of performance of a frequency-dimension initial synchronization acquisition and cell searching algorithm that applies hard-limiting to a received signal according to an embodiment of the present invention.

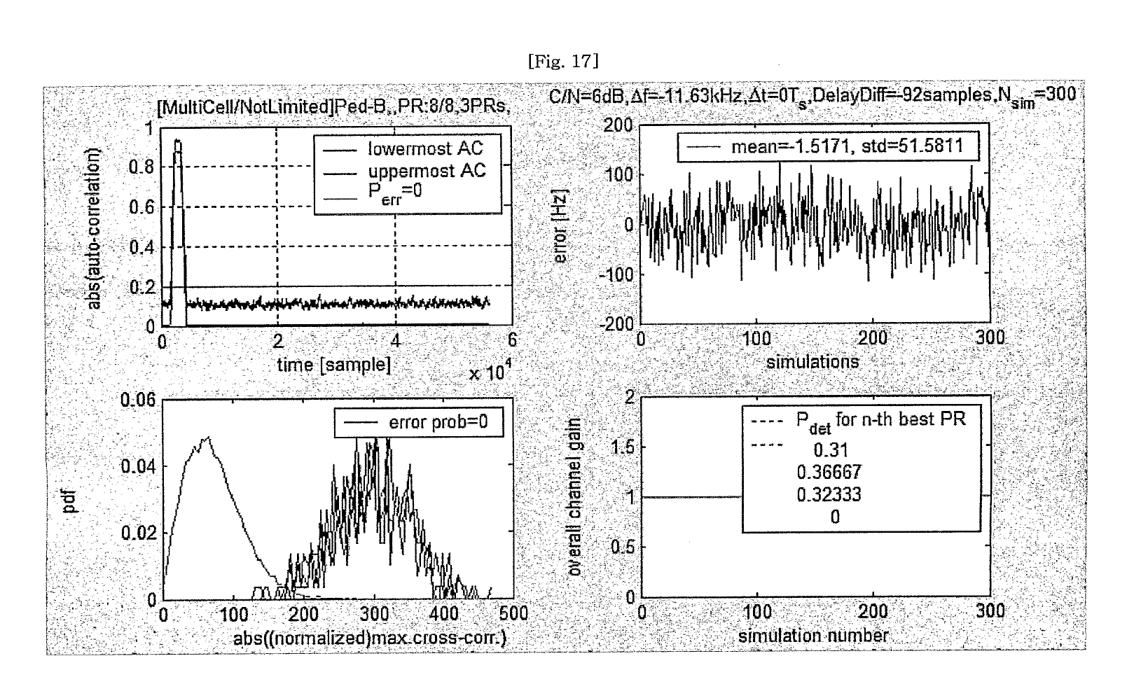

FIG. 17 shows the result of a simulation of performance of an auto-correlation-based frame synchronization acquisition and cell searching algorithm for a multi-channel environment having a fixed path gain according to an embodiment of the present invention. From the result shown in FIG. 17, it can be known that the auto-correlation-based algorithm has the performance for the channel having a fixed path gain channel, which is similar to the performance for the channel having a time-varying path gain. The lower right graph of FIG. 17 represents detection probability by paths. The graph shows that three different preamble signals are observed at a probability of approximately ⅓, respectively, because the preamble signals are received with the same path gain.

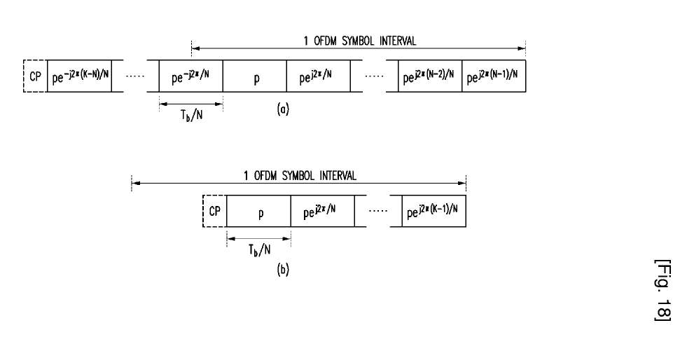

In a frequency-selective fading channel environment, performance deterioration occurs even when differential demodulation is used. In the case of a terminal, which is located at a cell boundary and thus receives overlapped downlink signals from a plurality of adjacent cells, cell search and identification become more difficult. To solve this problem, the present invention provides a method of defining cell groups having different positions of subcarriers constructing a preamble to arrange adjacent cells such that the adjacent cells belong to different cell groups. Here, the preamble in the time dimension is not constructed such that a specific pattern is repeated but has a form in which a specific pattern is subjected to phase shift, as shown in FIGS. 18 (a) and 18 (b). FIG. 18(a) illustrates a case in which the total length of a time-dimension preamble exceeds a single OFDM symbol interval when adjacent cells have different subcarrier positions, and FIG. 18(b) illustrates a case in which the total length of the preamble is shorter than the single OFDM symbol interval.

When the cell groups have different subcarrier positions but use the same subcarrier symbol stream, a difference between the subcarrier positions of the cell groups should be larger than twice an initial carrier frequency offset. When the cell groups respectively have different subcarrier positions and use different subcarrier symbol streams, there is no restriction on a difference between the subcarrier positions of the cell groups. When the respective cell groups have different subcarrier positions and the cells are appropriately arranged such that interference between cells having the same subcarrier position is sufficiently reduced, there is no collision of preamble signals and thus even channel estimation can be carried out using preambles.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the present invention, time and frequency resources can be effectively utilized while mitigating restrictions on frame structure design. Furthermore, the present invention provides the cross-correlation-based algorithm and auto-correlation-based algorithm as an initial synchronization acquisition method. The two algorithms complement each other. Moreover, the algorithms employ hard-limiting to remarkably reduce complexity in constructing the algorithms and eliminate a normalization process. Furthermore, a large number of preamble patterns can be unrestrictedly generated based on preamble patterns in the frequency dimension.

1. A method for constructing a frame preamble in an OFDM wireless communication system, comprising:
a) arranging a preamble after a CP (cyclic prefix) located at the head of a frame; and
b) repeatedly arranging a pattern, which has a length shorter than a single OFDM symbol interval, an integer number of times.

2. The method as claimed in claim 1, wherein the pattern shorter than a single OFDM symbol interval is phase-shifted in the time dimension, and is repeatedly arranged an integer number of times such that adjacent cells have different subcarrier offsets of pilot subcarriers arranged at a specific interval in the frequency dimension.

3. The method as claimed in claim 1, wherein, when the length of an effective OFDM symbol interval other than the CP is T_{b}, the length of the pattern is T_{b}/N (N is a positive integer) and the preamble is constructed in a manner such that the pattern having the length of T_{b}/N is repeated K times (K is a positive integer).

4. The method as claimed in claim 1, wherein the length of the CP is 0.

5. A method for acquiring frame synchronization and searching cells based on cross-correlation using a preamble having a length that does not correspond to an integer number of times an OFDM symbol interval, comprising:
a) observing cross-correlation of a received signal and reference patterns and detecting the moment when the absolute value of cross-correlation exceeds a pre-determined threshold to acquire frame synchronization; and
b) observing cross-correlation of the received signal and reference patterns after the frame synchronization is acquired and detecting the moment when the absolute value of cross-correlation exceeds the pre-determined threshold to carry out cell search.

6. The method as claimed in claim 5, wherein the a) and b) comprise:
i) measuring the power level of the received signal;
ii) normalizing a result of calculation of the cross-correlation using the measured power level; and
iii) applying the normalized result to the threshold.

7. The method as claimed in claim 6, wherein, when the normalized result is applied to the threshold, the normalized result is multiplied by a weight and applied.

8. The method as claimed in claim 5, wherein hard-limiting is applied to the received signal and the cross-correlation is executed.

9. The method as claimed in claim 6, wherein hard-limiting is applied to the reference patterns and the cross-correlation is executed.

10. The method as claimed in claim 5, wherein noncoherent combining of a predetermined number of times is applied to the absolute value of the cross-correlation and compared to the threshold.

11. The method as claimed in claim 5, further comprising calculating an average phase difference among the repeated patterns constructing the preamble appearing during a predetermined interval to estimate a carrier frequency based on the frame synchronization acquired at the a) after the b).

12. The method as claimed in claim 11, further comprising comparing absolute values of results obtained by OFDM-demodulating a preamble signal for which an error of the estimated carrier frequency has been compensated and cross-correlating the preamble signal and reference patterns in the frequency domain to search for an optimum cell after the carrier frequency is estimated.

13. The method as claimed in claim 12, wherein, when the preamble is shorter than a single OFDM symbol interval, an interval of the preamble, which has a length corresponding to a positive integer number of times the length of the pattern, is input to a part of an FFT input vector for OFDM demodulation, and the remaining components of the FFT input vector are filled with 0's, and then FFT is carried out.

14. The method as claimed in claim 12, wherein, when the preamble is longer than a single OFDM symbol interval, an interval having a length corresponding to a positive integer number of times the length of the pattern is selected from the interval of the preamble, which is shorter than a single OFDM symbol interval, other than the interval of the preamble corresponding to an integer number of times a single OFDM symbol interval, the selected interval is input to an FFT input vector for OFDM demodulation, the remaining components of the FFT input vector are filled with 0's, and then FFT is carried out.

15. A method for acquiring frame synchronization and searching cells based on a cross-correlation using a preamble having a length that does not correspond to an integer number of times an OFDM symbol interval, comprising:
a) observing auto-correlation having a time interval of a basic pattern constructing a preamble for a received signal;
b) normalizing the observed auto-correlation using the power level of the received signal;
c) detecting the moment when the absolute value of the normalized result exceeds a predetermined threshold to acquire frame synchronization; and
d) after the frame synchronization is acquired, observing auto-correlation having the time interval of the basic pattern constructing the preamble for the received signal to carry out cell search.

16. The method as claimed in claim 15, wherein, when the result of calculation of auto-correlation is applied to the threshold in the c), the calculation result is multiplied by a weight and applied to the threshold.

17. The method as claimed in claim 15, wherein noncoherent combining of a predetermined number of times is applied to the absolute value of the auto-correlation and compared to the threshold.

18. The method as claimed in claim 15, further comprising calculating an average phase difference among the repeated patterns constructing the preamble appearing during a predetermined interval to estimate a carrier frequency based on the acquired frame synchronization between the c) and d).

19. The method as claimed in claim 18, further comprising comparing absolute values of results obtained by OFDM-demodulating a preamble signal for which an error of the estimated carrier frequency has been compensated and cross-correlating the preamble signal and basic patterns in the frequency domain to search for an optimum cell after the d).

20. The method as claimed in claim 15, wherein hard-limiting is applied to the received signal and the auto-correlation is executed.

21. The method as claimed in claim 15, wherein the preamble is constructed in a manner such that a specific pattern is repeated having a predetermined phase shift in the time dimension, and adjacent cells have different subcarrier offsets of preamble pilot subcarriers arranged at a specific interval in the frequency dimension.

22. The method as claimed in claim 19, wherein, when the preamble is shorter than a single OFDM symbol interval, an interval of the preamble, which has a length corresponding to a positive an integer number of times the length of the pattern, is input to a part of an FFT input vector for OFDM demodulation, and the remaining components of the FFT input vector are filled with 0's, and then FFT is carried out.

23. The method as claimed in claim 19, wherein, when the preamble is longer than a single OFDM symbol interval, an interval having a length corresponding to a positive integer number of times the length of the pattern is selected from the interval of the preamble, which is shorter than a single OFDM symbol interval, other than the interval of the preamble corresponding to an integer number of times a single OFDM symbol interval, the selected interval is input to an FFT input vector for OFDM demodulation, the remaining components of the FFT input vector are filled with 0's, and then FFT is carried out.
